(19) United States
(12) Patent Application Publication
(10) Pub. No.: US 2015/0056849 A1
(43) Pub. Date: Feb. 26, 2015

(54) Electrical Outlet Receptacle Access Relocation Device

(71) Applicants: Michael Lynn Garner, Gray, TN (US); Daniel Jonathan Jones, Maryville, TN (US)

(72) Inventors: Michael Lynn Garner, Gray, TN (US); Daniel Jonathan Jones, Maryville, TN (US)

(21) Appl. No.: 13/974,013

(22) Filed: Aug. 22, 2013

(51) Int. Cl. H01R 13/58

(52) U.S. Cl. CPC H01R 13/5841
USPC 439/502

(57) ABSTRACT

A self-contained, readily adaptable electrical device having a first, comprising conductors connected in common and adaptable thereto an existing duplex receptacle and receivable of and transferring mains only therefrom, providing no electrical plug in access thereat, therefore mains through conductors connected in common to a wire type therein first and within a conduit type connectable by a conduit connector, having method of attachment to first, allowing said conduit to a second, connectable thereto conduit and wire of first having same method of attachment and wire connected in common therein second to a corresponding duplex receptacle attached therein as a relocated receptacle option thereby a providing a fully adjustable second of the first and second having a corresponding receptacle allows novice individuals to temporarily or permanently relocate an existing hidden or difficult to access electrical receptacle thereat first to an adjacent location by second, for easier and safer receptacle access.

### CROSS-REFERENCED TO RELATED APPLICATIONS

The present application claims the benefit and priority of U.S. Provisional Application No. 61/742,963, Filed Aug. 23, 2012 Titled, Electrical Outlet Receptacle Relocation System/Device, of which the entire disclosure of is incorporated by reference herein.

### STATEMENT REGARDING FEDERALLY SPONSORED RESEARCH OR DEVELOPMENT

Not applicable.

### BACKGROUND OF INVENTION

1. Technical Field of Invention

Electrical power outlet receptacles routinely become partially obscured or blocked from access due to placement of furniture in homes and office furnishings or items and causing difficulties or at best is very annoying and many times can be dangerous when attempting to move said furniture or office items when attempting to access an obscured outlet receptacle to plug in an electrically powered device. The inventors are aware of inadequacies of current methods utilized such as extension cords, power strips, complicated electrical raceways or track systems and patented systems or devices not proven or not certified as to their safety or functionality due to some having questionable or impractical designs or methods.

The invention of this application discloses an adaptable device, having two different housings connectable thereof and in common by a wire type within a conduit means in common to an electrical receptacle comprising a novel, self-contained, readily adaptable device allowing individuals to temporarily or permanently relocate existing outlet receptacle access from difficult to access locations to adjacent locations, horizontally, left or right, and/or vertically, above or below, or any combination thereof said location, by a corresponding alternative receptacle, to a better location providing easier and safer receptacle access.

2. Disclosure of Prior Art

Prior art listed is similar as to solutions to the problem disclosed above and as to what is claimed for the device of this application however all prior art forms utilize untested methods and devices and some not adhering to national or international electrical standards. Morin, U.S. Pat. No. 5,700,150, Dec. 23, 1997, Electrical Outlet Type Extension Cord Real with Auxiliary Outlet, shows an electrical device that connects to wall outlet receptacles providing a direct plug in ability thereat and comprising a reel method having a length of ungrounded common extension connected to a duplex three prong receptacle type. Morin has some claims similar to the device of this application but would be clearly would be clearly superior by anyone skilled in the art. Additionally his specifications clearly states the devices receptacle extension method is temporary function and when until no longer needed, wind it back into said housing and stored there till use is required again. Morin clearly utilizes a simple extension cord with no ground wire connected to a three prong type receptacle having no method of ground which could make individuals think it is a grounded circuit and is clearly a critical safety issue and not the case of the device of this application which adheres to strict electrical industry standards and regulations as either a temporary or a permanent device.

Elmouchi, U.S. Pat. No. 5,788,517, Aug. 4, 1998, Cordless Extension System, shows a system of attachable housings and connectable components, molded straight and corner track sections, and various covers for providing safety and decor for exposed track sections having embedded wire within and on said track that when assembled provides individuals the ability to add electrical outlet boxes, receptacles, switches, light fixtures, etc., to change or add electrical accesses or outlet locations along walls, partitions. The array of components disclosed would show individuals, experienced in the field of endeavor, said system is not a device, not self-enclosed, and not readily adaptable, as the device of this application clearly provides.

Hicks, U.S. Pat. No. 7,220,128, May 22, 2007, Titled, Extendable Power Source Device, and Harbertson, U.S. Pat. No. 6,004,138, Dec. 23, 1997, Titled, Electric Outlet Extender, showing nearly identical devices with various components having additional sliding and telescoping components within another and wire strips embedded thereon inwardly with electrical contacts that allow said components to slide along while still maintaining solid continuity. The inventors of this application question the unsubstantiated and probably untested connection method of their devices and ability to gain certification or approval for such contacts methods due to potential loosening, creating heat, and thereby presenting a real fire hazard potential as anyone skilled in electrical methods and device standards would question before such designs could warrant approval for marketing to the public. Another disadvantage of Hicks and Harbertson's devices relates to their aesthetic qualities and in reality, would not be pleasing or very acceptable to individuals when attaching objects to the walls in their homes or any other building types. The device of this application provides a corresponding receptacle for relocating, closely resembling if not identical existing hidden or difficult to access receptacles and in a standard vertical orientation and definitely looking more like a common receptacle that most individuals could not differentiate from original and the device of this application utilizes commonly accepted electrical components for reliability and assurance concerning safety.

### SUMMARY OF INVENTION

The device presented in this application is a fully assembled and readily adaptable device comprising; a first housing having conductors and grounded circuit adaptable to common duplex receptacles, after removing the receptacle cover, and securable thereto by first receivable of mains power and transferring through said conductors wired in common to a wire means therein first and wire channeled therefrom by a flexible conduit type connected by a conduit connector having an attachment method that allows conduit to traverse or swing up to 180 degrees, left or right, of said first housing when adapted to existing location, and said conduit connectable to a second housing, having same said method of attachment providing same 180 degree horizontal rotational adjustments. left or right, and said wire of a first connected in common to a duplex receptacle adapted therein and having an common receptacle cover and providing the alternative receptacle for relocating said difficult access receptacle by physically relocating second housing left or right of the first housing, and by nature of flexible conduit, allows vertical adjustment options above or below said first, and any in between adjustments, thereby allowing novice individuals, having common experience with household tools, the ability to relocate duplex receptacles, in difficult to see and/or difficult access locations, to an alternative temporary or permanent location, for easier and safer receptacle access.

For illustration purposes drawings for said device of this application depicts; a first housing, having preformed conductor with ground pins as is common for common duplex grounded receptacles and transfers mains power only from first, having no power cord plug in access thereat, and first is connected to an approved wire type, channeled within an approved flexible conduit, and conduit is connectable to first by a conduit connector, having a special method of attachment therein and thereto first, and then connected by same said wire, connector, and conduit is a second housing providing a corresponding alternative receptacle of said device presented. The device is not limited in scope to duplex receptacles only, in that said device can adapt many types of electrical wall receptacles within said second housing, up to and including 50 amp 250 volt receptacles when utilizing corresponding heavy duty male blade conductors thereat first housing and slightly larger conduit a connectors and appropriate rated wiring type.

### BRIEF DESCRIPTION OF DRAWINGS

FIG. 1 depicts a frontal plan view of a second housing.

FIG. 2 depicts a frontal plan view of a first housing.

FIG. 3 depicts a 180 degree rotational rear plan view of a second housing.

FIG. 4 depicts a 180 degree rotational rear plan view of a first housing.

FIG. 5 depicts a top plan view of a second housing.

FIG. 6 depicts a top plan view of a first housing.

FIG. 7 depicts a front perspective view of rear component of second with an adapted receptacle therein and a conduit connector having an attachment ring.

FIG. 8 depicts a front perspective view of rear component of first with metal conductors therein and a conduit connector having an attachment ring.

FIG. 9 depicts a bottom exploded view of second housing with conduit opening.

FIG. 9a depicts a bottom exploded view of first second housing with conduit opening.

FIG. 10 depicts a front plan view of device providing another second housing option.

FIG. 11 depicts a front plan view of a power cord retaining clip.

FIG. 11a depicts a plan side view of a power cord retaining clip.

FIG. 12 depicts device relocating second housing left or right of existing receptacle.

### DETAILED DESCRIPTION OF DRAWINGS

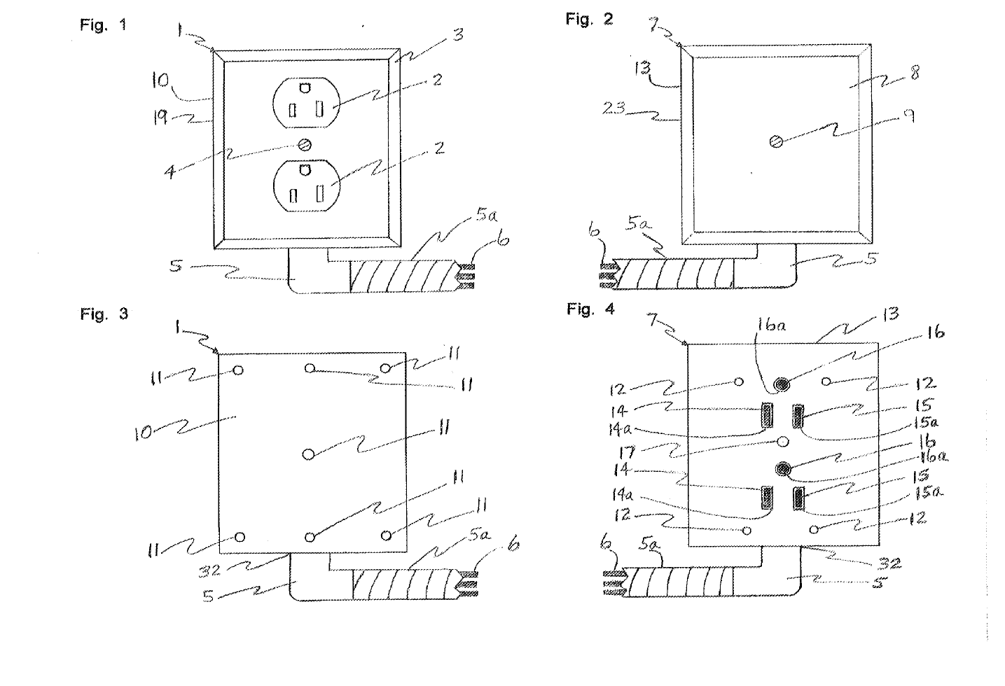

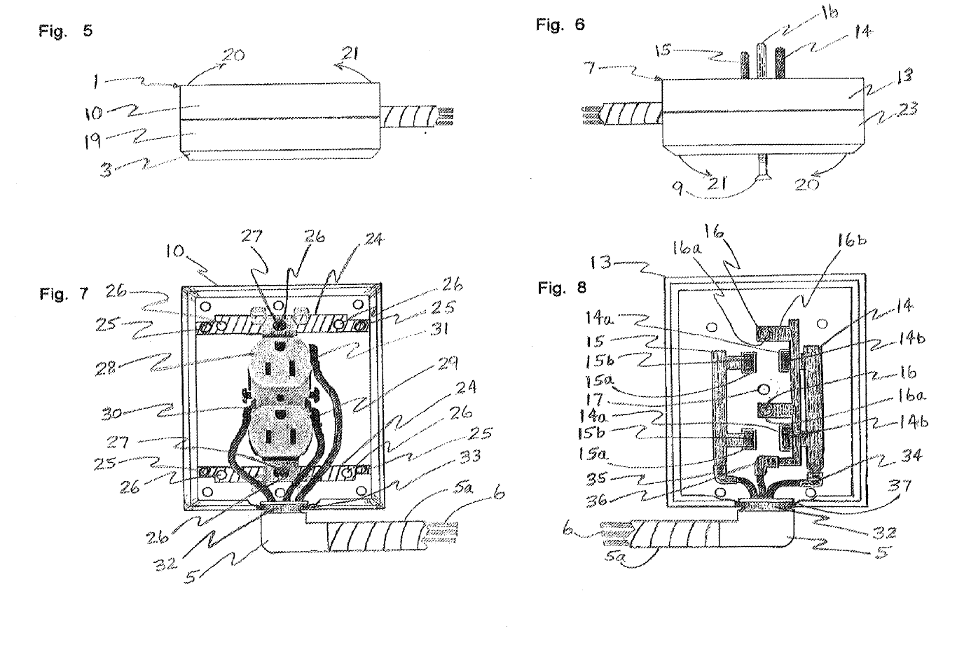

FIG. 1 is a frontal view of a second housing 1 comprising of components 10 and 19 depicted also in FIG. 5 and having a common three prong duplex receptacle type 2 adapted therein also depicted in FIG. 7 and showing a standard duplex receptacle cover type 3 with cover retainer screw 4 thereat and 1 connectable thereto a 90 degree conduit connector type 5 and having flexible conduit 5a, ranging from two feet to six feet as will be standard. channeling at least a 14 AWG wiring type 6 therein hardwired in common to said receptacle 2.

FIG. 2 is a frontal view of a first housing 7 comprising of components 13 and 23, also in FIG. 6, showing 23 having a plain frontal surface 8 with an electrical receptacle attachment screw 9 thereat and 7 connectable thereto a 90 degree conduit connector type 5 connected to same conduit channeling same wire of second and hardwired in common therein 13 to preformed metal strip conductors in FIGS. 4, 6, and 8.

FIG. 3 is a 180 degree rotated rear plan view of 1 of FIG. 1 depicting a plain housing rear 10 incorporating attachment holes 11 as wall or partition mounting hardware attachment options, included with device, and 1 connectable thereto a 90 degree conduit connector 5 having an attachment method 32 depicted in FIGS. 7 and 9, and 5a and showing same said conduit and wire.

FIG. 4 is a 180 degree rotated rear plan view of 7 of FIG. 2 depicting rear housing component 13 incorporating housing component attachment holes 12 thereat for assembling component 13 to component 23 shown in FIG. 6, which incorporates internally molded column style hardware guides and housing supports therein, not shown, thereby comprising 7 and further depicting male blade conductors 14 and 15 and ground pins 16 thereat vertically aligned, and extending orthogonally rearward of 13 through slots 14a, 15a, and holes 16a thereat 13 and traversing inward therein 7 also depicted in FIG. 8, with said conductors hardwired in common to mains therein and incorporating hardware attachment hole 17 thereat center of 8 and through 7 as depicted in FIG. 6, for securing 7 to existing duplex receptacles after removing receptacle's cover, not shown, and 7 connectable to 5 and having a method of attachment 32 depicted in FIGS. 8 and 9, and 5a and showing same said conduit and wire.

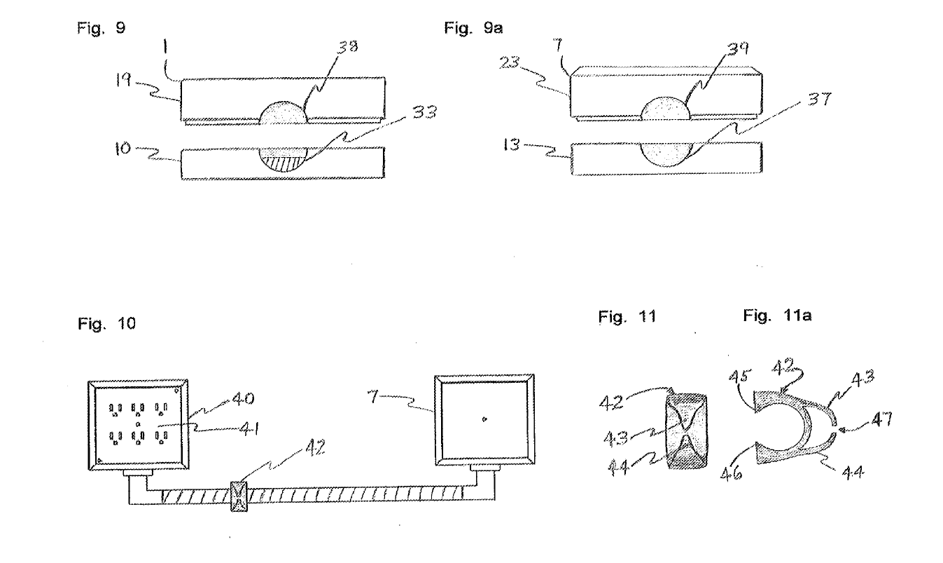

FIG. 5 is a top plan view depicting second housing 1 comprising of assembled components at manufacture 10 and 19 and a receptacle cover 3 and depicting housing 1 providing up to 180 degree horizontal adjustment options 20, left to right, and 21, right to left, allowable by attachment method 32 shown in FIGS. 7 and 9.

FIG. 6 is a top plan view depicting 7 comprising of components 13 and 23 assembled at manufacture and having preformed metal blade conductors 14 and 15 and ground pins 16 vertically aligned extending orthogonally rearward through slots thereat 13, not shown, and having a receptacle attachment screw 9 centered frontally thereat and through 23 and 13 for securing 7 to existing duplex outlet receptacles, not shown, and housing 7 providing up to 180 degree horizontal adjustment options 20, right to left, and 21, left to right, allowable by attachment method 32 shown in FIGS. 8 and 9.

FIG. 7 depicts a front perspective view of 10 with component 19, and cover 3 removed and 10 comprising molded supports 24 having hardware attachment points 25 for assembling structures 19 to 10 at manufacture and further showing four of six hardware attachment points 26 for common electrical receptacle types, two points 26 are utilized for receptacle 28, and all points 26 correspond with NEMA guidelines for single and duplex electrical receptacle hardware attachment patterns. FIG. 7 further depicts a common three prong duplex receptacle 28 adapted thereon supports 24 securely attaching 28 by screws 27 and further, receptacle 28 is hardwired in common to wire type 6 to, neutral 29, hot 30, and ground 31. FIG. 7 further still depicts conduit 5a connected into 90 degree conduit connector 5 having a molded concave ring 32 of less diameter than component 10 attachment opening 33, also depicted in FIG. 9, thereby connector 5 inserted into opening 33, when components 10 and 19 of FIG. 6 are assembled at manufacture, provides housing 1 horizontal rotation adjustments of 180 degrees, left to right or right to left, as stated in FIG. 5, as needed when relocating access point of receptacle 28 of housing 1.

FIG. 8 depicts a front perspective view of component 13 with component 23 removed showing three preformed metal strip conductors: strip 14 formed of two vertical aligned blades orthogonally rearward of 13 of FIG. 6, traversing back inwardly through corresponding slots 14a forming to 90 degree bends 14b of strip 14 and further traversing to spade style end, not shown, and wired to high temperature steel female spade connector 34 in common to mains neutral, and strip 15 formed of two vertical aligned blades orthogonally rearward of 13 of FIG. 6, traversing back inwardly through corresponding slots 15a and forming to 90 degree bends 15b and to strip 15 and further traversing to a spade style end, not shown, and wired to said steel female type spade connector 35 in common with mains hot, and two ground pins 16, vertically aligned, centered between 14 and 15, and orthogonally rearward of 13, of FIG. 6, traversing inward through holes 16a to strip 16b, where having been connected and welded 16 traversing to a spade style end, not shown, and wired in common with ground by said high temperature steel female connector 36. FIG. 8 further still depicts conduit 5a connected into 90 degree conduit connector 5 having a concave ring 32 of less diameter than conduit attachment opening 37, also depicted in FIG. 9, thereby connector 5 inserted into opening 37 when components 13 and 23 of FIG. 5 are assembled at manufacture, provides first housing 7 horizontal rotation adjustments of 180 degrees, left to right or right to left, as needed when relocating access point of receptacle 28 of housing 1.

FIG. 9 depicts bottom exploded view of second housing 1, comprising of components 10 and 19 as in FIG. 5 and second housing 1 depicting conduit attachment semicircular opening 33 and 38 respectfully forming the circular conduit connector attachment opening when said components 10 and 19 are assembled during manufacture.

FIG. 9a depicts bottom exploded view first housing 7, comprising of components 13 and 23 as in FIG. 6 and first housing 7 depicting conduit attachment semicircular opening 37 and 39 respectfully forming the circular conduit connector attachment opening when said components 13 and 23 are assembled during manufacture.

FIG. 10 depicts device having a second housing 40 as a multiple plugin style receptacle option 41 and having a power cord retainer 42 attached to conduit. First housing 7 is the same as previous drawings shown and specifications stated thereby having only to utilize a modified molded second housing 40 for supports, guides, and isolation structures for alternative sets of preformed metal strip conductors comprising of female style inwardly curving winged conductor ends, not shown, just inward of hot and neutral frontal slots, as female receptacles with ground pin receiver holes only depicted on 41, therefore utilizing same basic device design yet having a multiple plugin type receptacle 41 as second housing.

FIG. 11 depicts power cord retainer 42 of FIG. 10 having a frontally, top forming and downward tapering curvature 43 terminating about midpoint of retainer. Retainer 42 also having a frontally, bottom forming and upward tapering curvature 44 terminating about midpoint of retainer. Both tapering curvatures 43 and 44 meet midpoint but do not meet thereby forming opening 47 for inserting power cords of devices when said are utilizing the relocated receptacle, retaining them in neat order, off floors, and back along conduit out of sight.

FIG. 11 a depicts a plan side view of retainer 42 depicting a perspective of base retainer 42 having a semi-circular conduit attachment clip 45 and 46 as method of attaching to and also removable from flexible or rigid conduit types and 42 having partially open curvatures 43 and 44 frontally as described in FIG. 11.

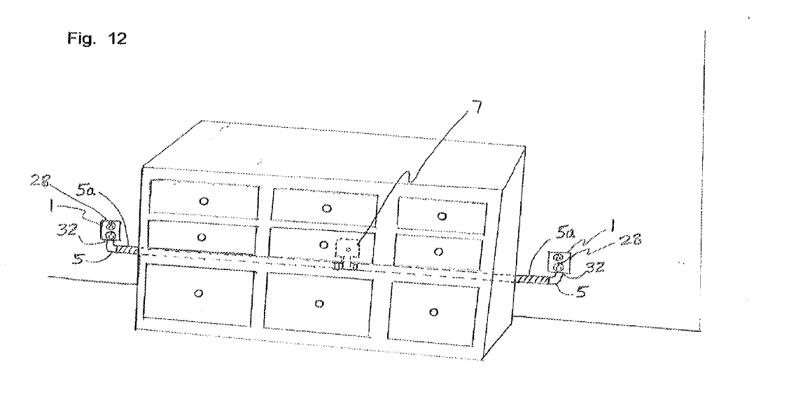

FIG. 12 depicts as one example of device utilization thereby a first 7, depicted in FIGS. 2, 4, 6 and 10 adapted to an existing common duplex receptacle not shown and hidden behind a common chest of drawers, connected by wiring 6 in FIGS. 1, 2, 3, 4, 7, and 8 within flexible conduit 5a depicted in FIGS. 1 to 4, and 7 to 8, connected by a conduit connector 5 depicted in previous FIGS. 1 to 4, and in 7 and 8, having an attachment method 32 depicted in FIGS. 3, 4, 7, and 8, connected to second housing 1 providing an alternative relocated common duplex receptacle 28 depicted in FIGS. 1 and 7 to the right of said receptacle and also depicting the devices ability of said housings rotation abilities and by the conduit connection method 32 allowing conduit and said 1 traverse or swing back across 7 allows 1 to be relocated to the left of said existing hidden receptacle as desired or required by individuals thereby to a point adjacent of 7 for better and safer receptacle access.

The drawings of this application depicts only one electrical receptacle type utilized for application purposes therefore the scope of what can be accomplished by the design of the device in this application is not limited to disclosure only, or by the housings, their adaptive capabilities, various type and forms of conduit and conduit connectors, or wire types utilized, can easily accomplished and would be readily apparent to one skilled in the art, as easily within the scope of the invention's abilities. The depiction in FIG. 12 only shows one method of relocation, not showing the vertical adjustment abilities, therefore not depicting the full range of relocation adjustment abilities of the invention herein.

Further stating, it is not the intent of the inventors of the device of this application to imply any patentability of common electrical receptacles, conduits utilized, or wire types, that are commonly available as “off-the-shelf” items, but only to show the novelty of the device, it's abilities, the adaptable potential of the second housing, and a conduit connection method illustrated and disclosed for the many areas of adaptability of common receptacle types, conduit types, and wire types in residential and commercial applications, including specialty markets such as hospitals and industries or manufacturing dealing with sensitive equipment and devices where wall construction for adding or changing electrical wail boxes to move or relocate receptacles and other electrical items could or would present problems or situations of increased risk but could be avoided or alleviated totally by utilizing the device presented herein because of its quick adaptability and simple basic utility. Additionally specifications herein stating hardware items for attaching said second housing and securing flexible conduit lengths between housings to walls or partitions would be included for at least two wall mounting methods, plastic wall anchors with corresponding hardware, and attachable and removable glue type strips, all commonly available and proven over many years to be secure and durable methods by industry standards and codes set forth.

What is claimed is:

1. An electrical device comprising of:
a first housing adaptable and securable to existing duplex receptacles receivable of and transferring mains power by metal conductors connected in common to a wire type therein, and
said wire channeled through a conduit connector thereat first having a method of attachment,
allowing a first housing rotational adjustments and
a flexible conduit, connected by said connector, traverses left or right and/or above or below a first, and
wire and connector and conduit of first connectable to a second housing, and
having same connector type and same method of attachment thereto, thereby
allowing second housing rotational options, and
by same conduit thereto allowing second to traverse left or right and/or above or below said first, and
second supportive internally of at least one common duplex receptacle therein connected in common to wire type and conduit of first, and
a second receivable of mains from a first by a receptacle enclosed therein and having a common receptacle cover, thereby providing a first adaptable to a receptacle and a first connectable to a second providing an alternative receptacle for relocating and existing obscure or difficult to a access receptacle to an adjacent location for easier and safer access.

2. A first housing of claim 1 comprising of two molded components assembled during manufacture; a rectangular front component and a rectangular rear component both incorporating support and alignment structures therein, not shown, for hardware attachment and three preformed conductor strips,
two having 2 male blades vertically aligned, orthogonally of rear and traversing therefrom blades inward thereof rear turning 90 degrees forming two strips terminating to spade style wire connectors therein, one in common to mains hot and one in common to mains neutral, and
having two hollow pins vertically aligned, orthogonally and centered between each said blade sets traversing straightway inwardly of rear and connected to a third strip traversing and forming to a spade style connector in common to ground where each said strip is connected therein first to said wire type by hi-temperature female spade connectors with said wire channeled through flexible conduit type therefrom first to a second.

3. A front component of claim 2 having molded rectangular sides, enclosed frontally having a plain surface with four tapering sides and corners thereon, and a centered hole thereat and through rear as a hardware attachment point securing said to existing duplex receptacles, and
having a molded cut-out centered thereon bottom of said forming a half circular opening as said conduit connector opening and attachment method when assembled to rear component during manufacture.

4. A rear component of claim 2 having molded rectangular sides, enclosed on rear and having four slots and two holes there through, vertically aligned, orthogonally, and supporting said first conductor blades and round pins, and
having a molded cut-out centered thereon bottom of said forming a half circular opening as said conduit connector opening and attachment method when assembled to front component during manufacture.

5. A second housing of claim 1 comprising of two molded components assembled during manufacture; a rectangular rear component having a smooth surface aft with six holes as hardware attachment options thereat and open frontally with molded hardware guides and support structures thereon, not shown, extending upward of each said hole and incorporating two additional support structures between said guides and supports aligned to NEMA standards for adapting single or duplex electrical receptacles thereat and having said standard hardware attachment points thereon said supports for attaching receptacles.

6. A front component of claim 5 molded having rectangular sides only, having no rear or front enclosure, connectable thereto said rear component frontally during manufacture and supportive of common single or duplex electrical receptacle covers thereon, and
having a cut-out centered thereon bottom of said component forming a half circular opening as said conduit connector opening and attachment method when assembled to rear component during manufacture.

7. A rear component of claim 5 molded having rectangular sides formed outward of an enclosed back with plain surface incorporating six hardware attachment holes thereat and corresponding hardware guides and supports, not shown, connecting said rear to said front when assembled, and
having a cut-out centered thereon bottom of said component forming a half circular opening as said conduit connector opening and attachment method when assembled to front component during manufacture.
Conduit connectors of claim 1 each having a concave ring formed thereon, just preceding housing connector end, having less diameter than housing openings, provide secure housing connector secure attachments when housing components are assembled at manufacture, and said clearance between components and connectors allow housing rotation of each up to 180 degrees left or right as needed and facilitates traversing of conduit when relocating second housing from a first.

8. A second housing of claim 1 having multiple linear adjustment options, horizontally left or right, and vertically above or below, said first housing, when a first is attached thereto and thereon a receptacle's location, by nature of the flexible conduit type.

9. A power cord retainer clip comprising;
a base structure molded of a plastic or nylon formed as an open rear semi-circular ring, and
attachable to, and removable from, flexible and rigid conduit types, and
said base, about one half inch wide, not limited in scope to width or ring diameter attachment capabilities, and
said base having partially open loops frontally, one forming thereof top, curving and tapering centrally outwardly and downward terminating but not closing, and
another forming thereof bottom, curving and tapering centrally outwardly and upwardly terminating not closing, therefore
said frontal curvatures not meeting or enclosing allow power cords, plugged into receptacle of said device's second housing, to be attached thereto retainer by pressing cords through frontal opening retaining or supporting thereat conduit, off the floor and back along conduit out of sight, helping to prevent tangling of cords and provide a neat appearance.
